(19) United States
(12) Patent Application Publication
(10) Pub. No.: US 2026/0196455 A1
(43) Pub. Date: Jul. 9, 2026

(54) MEASUREMENT DEVICE AND MASS SPECTROMETER

(71) Applicant: Hitachi High-Tech Corporation, Minato-ku, Tokyo (JP)

(72) Inventors: Takuma NISHIMOTO, Tokyo (JP); Isao FURUYA, Tokyo (JP); Yuichiro HASHIMOTO, Tokyo (JP); Masuyuki SUGIYAMA, Tokyo (JP)

(21) Appl. No.: 18/863,752

(22) PCT Filed: Apr. 6, 2023
(86) PCT No.: PCT/JP2023/014169

§ 371 Date: Nov. 7, 2024

(30) Foreign Application Priority Data
Jun. 28, 2022 (JP) 2022-104041

(51) Int. Cl. H01J 49/00

(52) U.S. Cl. CPC H01J 49/0036

(57) ABSTRACT

A measurement device and a mass spectrometer capable of estimating a range of an abnormal portion that is a noise source of noise superimposed on a detection signal are provided.

In order to achieve the above object, a measurement device includes: a measurement unit configured to measure a measurement target and output a measurement signal; a detector configured to detect the measurement signal and output a detection signal; an analysis processing unit configured to calculate and output an analysis result from the detection signal; an analysis result display configured to display the analysis result; a device control module configured to control the measurement unit and output a control signal; and an abnormality detection module configured to detect noise in the measurement device. The abnormality detection module stores an enable interval of each of the components of the measurement device into a memory resource, and determines, for each of the components of the measurement device, whether the noise is mixed in based on the corresponding enable interval stored in the memory resource and the analysis result from the analysis processing unit.

### TECHNICAL FIELD

The present invention relates to a measurement device and a mass spectrometer.

### BACKGROUND ART

In recent years, measurement devices such as a mass spectrometer are used in various life sciences. In particular, a mass spectrometer that detects a measurement signal output from a measurement unit and performs component analysis on a sample is indispensable for drug discovery and drug testing in medical and pharmaceutical fields.

For example, PTL 1 is a related art in the present technical field. PTL discloses a unit for improving discrimination between a signal waveform and noise by preventing a waveform of a detection signal for an ion species of the same m/z from having a shape in which a plurality of peaks are connected due to the spread of the ion species having the same mass-to-charge ratio (m/z) during flight and a response time of a microchannel plate (MCP) in an ion analyzer.

### CITATION LIST

### Patent Literature

PTL 1: JP2019-114528A

### SUMMARY OF INVENTION

### Technical Problem

PTL 1 discloses noise reduction for a specific noise, but does not disclose identifying a noise source among a plurality of noises.

In particular, when a measurement device that obtains a measurement signal by identifying a noise component and improving a signal intensity of a detection target, there are the following problems. Noise that degrades an S/N ratio of the measurement unit includes, in addition to a detection signal of a sensor in the measurement unit other than the detection target, thermal noise at an environmental temperature, and the like, noise generated from another electrical device in the measurement device on which the measurement unit is mounted, and external noise entering from the outside of the measurement device. Examples of an electrical device in the measurement device that generates the noise include a switching power supply and a digital circuit. Examples of the external noise entering from the outside of the measurement device include other measurement device provided close to the measurement device, communication radio waves, and broadcast radio waves.

The noise superimposed on the measurement unit from such a large number of noise sources changes according to an operating environment of the measurement device, and there are situations in which noise that deviates from an assumed noise component and an assumed noise amount is superimposed on the measurement unit, degrading the S/N ratio and making it difficult to perform normal measurement. For example, there are situations in which when a portable wireless communication device is provided in the vicinity of the measurement device, or when a device cover is detached and attached again during maintenance of the measurement device, the attachment of the device cover is insufficient, a radio wave shielding effect assumed for the device cover is reduced, and when a connector of a cable is detached and attached, the attachment is insufficient. When such a situation occurs, it is necessary to check one device location in which normal measurement is performed one by one, and it takes a lot of time to identify a defective location.

The invention has been made to solve the above problem, and an object of the invention is to make it possible to estimate a range of an abnormal portion that is a noise source of noise superimposed on a detection signal of a measurement device.

### Solution to Problem

One example of the invention is a measurement device including: a measurement unit configured to measure a measurement target and output a measurement signal; a detector configured to detect the measurement signal and output a detection signal; an analysis processing unit configured to calculate and output an analysis result from the detection signal; an analysis result display configured to display the analysis result; a device control module configured to control the measurement unit and output a control signal; and an abnormality detection module configured to detect noise in the measurement device. The abnormality detection module stores an enable interval of each of the components of the measurement device into a memory resource, and determines, for each of the components of the measurement device, whether the noise is mixed in based on the corresponding enable interval stored in the memory resource and the analysis result from the analysis processing unit.

### Advantageous Effects of Invention

According to the invention, by making it possible to estimate a range of an abnormal portion based on an analysis result, it is possible to shorten a time for identifying a defective location of the measurement device and to reduce a maintenance time.

### BRIEF DESCRIPTION OF DRAWINGS

FIG. 1 is a configuration block diagram of a measurement device according to Embodiment 1.

FIG. 2 is a diagram showing a noise source in the measurement device.

FIG. 3 is a diagram showing an example of noise superimposed on an analysis result obtained by the measurement device.

FIG. 4 is a diagram showing an operation principle of a sync selector in Embodiment 1.

FIG. 5 is a processing flowchart of a syn determination unit in Embodiment 1.

FIG. 6 is a diagram showing an operation principle of a noise matcher in Embodiment 1.

FIG. 7 is a diagram showing an example of a result of determination obtained by a noise determination method according to Embodiment 2.

FIG. 8 is a configuration block diagram of a mass spectrometer according to Embodiment 2.

### DESCRIPTION OF EMBODIMENTS

Hereinafter, embodiments of the invention will be described with reference to the drawings.

### Embodiment 1

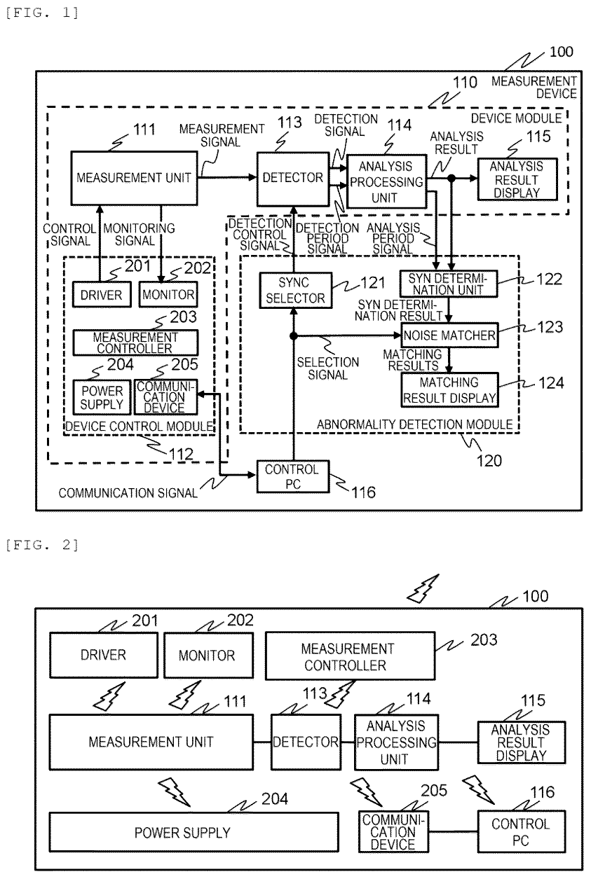

FIG. 1 is a configuration block diagram of a measurement device according to the present embodiment. In FIG. 1, a measurement device 100 includes a device module 110 that measures a measurement target and displays a result, an abnormality detection module 120 that determines a noise source of noise flowing in during measurement of the measurement device, and a control PC 116.

The device module 110 includes a measurement unit 111 that measures the measurement target and outputs a measurement signal, a device control module 112 that controls the measurement unit 111, a detector 113 that detects the measurement signal and outputs a detection signal, an analysis processing unit 114 that calculates and outputs an analysis result based on the detection signal, and an analysis result display 115 that displays the analysis result. The device control module 112 transmits a control signal to the measurement unit 111 by a control operation based on a communication signal of the control PC 116. Here, the analysis result display 115 may be included in the control PC 116.

The device control module 112 includes, for example, a power supply 204 that supplies power to components that are some or all of the units and modules constituting the measurement device 100, a driver 201 that drives the measurement unit 111, a measurement controller 203 that controls the driver 201, a monitor 202 that monitors an operation state of the measurement unit 111, and a communication device 205 that communicates with the control PC 116.

The abnormality detection module 120 is software processing for achieving various functions by a CPU executing operation programs for achieving the various functions, and is shown as a functional block diagram in FIG. 1. In FIG. 1, the abnormality detection module 120 includes a sync selector 121, a syn determination unit 122, a noise matcher 123, and a matching result display 124. The sync selector 121 has a memory resource described later that stores enable intervals, which are operating periods of some or all of the components in the measurement device 100, and outputs a detection control signal to the detector 113 at an operating period of the enable interval of the component designated by a selection signal input from the control PC 116. The syn determination unit 122 outputs a syn determination result from an analysis result and an analysis period signal output from the analysis processing unit 114. The noise matcher 123 outputs matching results which are noise sources estimated based on the syn determination result and the selection signal. The matching result display 124 displays the matching results from the noise matcher 123. The matching result display 124 may be included in the control PC 116.

Next, the noise superimposed on the analysis result and the noise source will be described. The noise superimposed on the analysis result is roughly classified into internal noise derived from components which are all units and modules included in the measurement device and external noise derived from outside of the measurement device.

FIG. 2 is a diagram showing the noise source in the measurement device. In FIG. 2, the internal noise is, for example, noise transmitted from the 204 to the measurement unit 111 and noise transmitted from the communication device 205 to the detector 113. The external noise is, for example, a wireless portable device disposed in the vicinity of the measurement device 100. Here, the transmission of the noise includes both conduction in which the noise is transmitted by flowing through a metal portion such as each module or a cover of the measurement device 100 and propagation in which a radio wave is transmitted within space.

The measurement device 100 implements noise countermeasures so that each noise does not affect the analysis result. For example, it is possible to shield external noise by forming the cover of the measurement device 100 into an electromagnetic wave shielding structure, shield noise from each unit or module by accommodating the detector 113 in the electromagnetic wave shielding structure, and reduce power supply noise by inserting a ferrite core into a power supply cable connecting the power supply and each unit or module.

However, during the operation of the measurement device 100, effects of the noise countermeasures may be reduced or lost, and the noise may be superimposed on the analysis result. For example, this occurs at the time of replacement of a periodically replaceable component in maintenance or at the time of replacement of a failed module. In such a case, the following work is performed, which is to open the cover of the measurement device, disconnect the various cables connected to a target module, remove the old module, install a new module, connect the various cables to the new module, and close the cover of the measurement device. At this time, when loosening of the cable and connector, contact failure of the cover of the measurement device, or the like occurs, the effect of the noise countermeasures is reduced or lost.

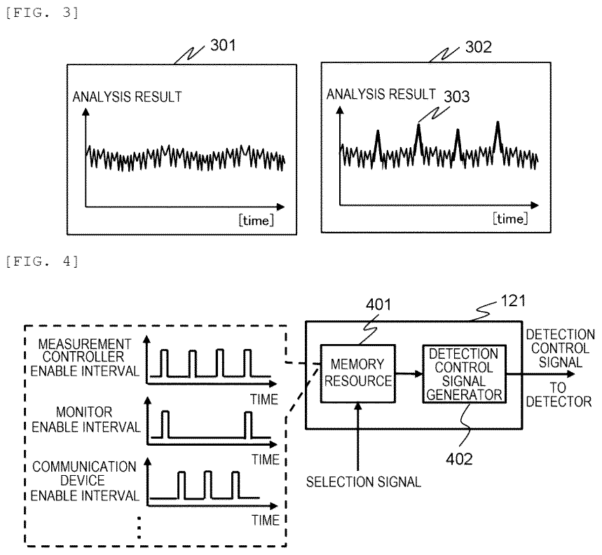

FIG. 3 shows an example of an analysis result when the effect of the noise countermeasures is reduced or lost. In FIG. 3, an analysis result 301 indicates a normal analysis result, and an analysis result 302 indicates an analysis result when noise 303 having a periodic pulse shape is superimposed. When the analysis result 302 is generated after the replacement of the periodically replaceable component in the maintenance or the replacement of the failed module, in the related art, a lot of work time is required because a work of checking again whether there is an error in contents of the work at the time of the replacement is generated and a work of checking one by one whether there is no problem in the replaced periodically replaceable component or replacement module is generated.

Next, a method for estimating a noise source of noise superimposed on an analysis result by the abnormality detection module 120 according to the present embodiment will be described. When the analysis result 302 shown in FIG. 3 is generated, the abnormality detection module 120 functions as a noise determination unit for displaying an estimated noise source on the matching result display 124.

FIG. 4 is a diagram showing an operation principle of the sync selector 121 in the abnormality detection module 120 according to the present embodiment. In FIG. 4, the sync selector 121 includes a memory resource 401 and a detection control signal generator 402, and switches the detection control signal for controlling a detection timing of the detector 113 based on the selection signal input from the control PC 116. The memory resource 401 stores the enable intervals, that is, drive periods, of some or all of the components that are the units or the modules included in the measurement device 100. For example, it is an enable interval of the measurement controller 203, an enable interval of the monitor 202, and an enable interval of the communication device 205. The sync selector 121 enables the detector 113 to perform a detection operation in a period same as the components selected by the control PC 116.

In FIG. 1, the detector 113 outputs the detection signal, which is a result obtained by detecting the measurement signal in synchronization with the detection control signal input from the sync selector 121, and a detection period signal, which is a detection control signal, to the analysis processing unit 114. The analysis processing unit 114 processes the input detection signal and outputs the analysis result to the analysis result display 115 and the syn determination unit 122. The input detection period signal is output to the syn determination unit 122 as the analysis period signal.

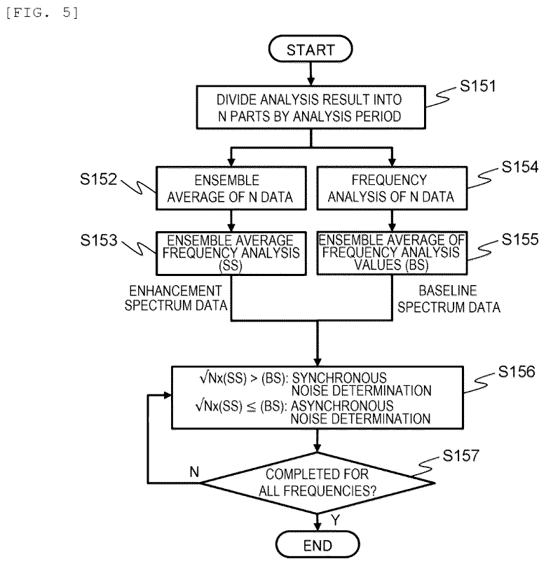

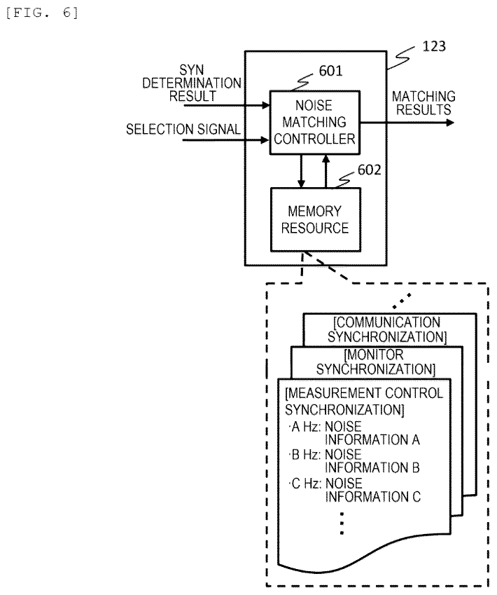

FIG. 5 is a processing flowchart of the syn determination unit 122 in the abnormality detection module 120 according to the present embodiment. The syn determination unit 122 outputs, based on the input analysis result and the analysis period signal, a frequency component of the analysis result and a syn determination result which is information on synchronization between the frequency component and the analysis period signal. Hereinafter, a method for calculating and determining the frequency component and the synchronization will be described with reference to FIG. 5.

An analysis result A is time series data of M points as in the following Formula (1).

$$\begin{matrix}[ Formula 1 ] & \\ A = [ {T}_{1} , {T}_{, 2} , {T}_{3} , … , {T}_{M} ] & ( 1 )\end{matrix}$$

In step S151, the time-series analysis result A is divided by the analysis period signal. When an analysis period is L and the number obtained by dividing the M points by L is N (N=M/L), the time series data obtained by dividing the analysis result into N based on the analysis period is expressed by the following Formula (2).

$$\begin{matrix}[ Formula 2 ] & \\ \begin{matrix}{A}_{1} = [ {T}_{1} , {T}_{, 2} , {T}_{3} , … , {T}_{L} ] \\ {A}_{2} = [ {T}_{1 + L} , {T}_{, 2 + L} , {T}_{3 + L} , … , {T}_{2 L} ] \\ {A}_{3} = [ {T}_{1 + 2 L} , {T}_{, 2 + 2 L} , {T}_{3 + 2 L} , … , {T}_{3 L} ] \\ ⋮ \\ {A}_{N} = [ {T}_{1 + ( N - 1 ) L} , {T}_{2 + ( N - 1 ) L} , {T}_{3 + ( N - 1 ) L} , … , {T}_{NL} ]\end{matrix} & ( 2 )\end{matrix}$$

Based on the N-divided analysis results, enhancement spectrum data and baseline spectrum data after statistical calculation for enhancing the components of the enable interval are calculated.

In step S152, the enhancement spectrum data is first calculated by calculating an ensemble average of the N-divided analysis results, and time series data TA of the ensemble average is obtained as in the following Formula (3).

$$\begin{matrix}[ Formula 3 ] & \\ TA = [ {TA}_{1} , {TA}_{, 2} , {TA}_{3} , … , {TA}_{L} ] & ( 3 )\end{matrix}$$

Each point of the time series data of the ensemble average is calculated by the following Formula (4).

$$\begin{matrix}[ Formula 4 ] & \\ {TA}_{n} = \frac{1}{N} {\sum }_{x = 0}^{N - 1} {T}_{n + x * L} & ( 4 )\end{matrix}$$

Next, in step S153, the time series data of the ensemble average is converted into a frequency component to obtain enhancement spectrum data SS as in the following Formula (5). For the conversion into the frequency component, for example, FFT (discrete Fourier transform) is used.

$$\begin{matrix}[ Formula 5 ] & \\ FFT ( TA ) = SS = [ {SS}_{1} , {SS}_{2} , {SS}_{3} , … , {SS}_{L / 2} ] & ( 5 )\end{matrix}$$

By obtaining the enhancement spectrum data based on the above calculation, among the frequency components included in the enhancement spectrum data, the frequency component synchronized with the analysis period signal maintains the same intensity as the analysis result, the frequency component randomly generated with respect to the analysis period signal attenuates by √N, and the frequency component of a signal having periodicity on a time axis generated non-synchronously with the analysis period signal attenuates by less than √N.

In step S154, the baseline spectrum data is first converted into frequency components by frequency analysis of A₁ to A_{N}, which are N-divided analysis results, as in the following Formula (6). The conversion into the frequency component uses the calculation same as that of the frequency analysis used in the enhancement spectrum data.

$$\begin{matrix}[ Formula 6 ] & \\ \begin{matrix}FFT ( {A}_{1} ) = {TS}_{1} = [ {TS}_{1}^{1} , {TS}_{2}^{1} , {TS}_{3}^{1} , … , {TS}_{L / 2}^{1} ] \\ FFT ( {A}_{2} ) = {TS}_{2} = [ {TS}_{1}^{2} , {TS}_{2}^{2} , {TS}_{3}^{2} , … , {TS}_{L / 2}^{2} ] \\ ⋮ \\ FFT ( {A}_{N} ) = {TS}_{N} = [ {TS}_{1}^{N} , {TS}_{2}^{N} , {TS}_{3}^{N} , … , {TS}_{L / 2}^{N} ]\end{matrix} & ( 6 )\end{matrix}$$

Next, in step S155, the ensemble average of A₁ to A_{N} subjected to the frequency analysis is calculated, thereby obtaining base spectrum data BS as in the following Formula (7).

$$\begin{matrix}[ Formula 7 ] & \\ BS = [ {BS}_{1} , {BS}_{2} , {BS}_{3} , … , {BS}_{L / 2} ] & ( 7 )\end{matrix}$$

Each point of the base spectrum data BS is calculated by the following Formula (8).

$$\begin{matrix}[ Formula 8 ] & \\ {BS}_{n} = \frac{1}{N} {\sum }_{x = 0}^{N - 1} {TS}_{n}^{x} & ( 8 )\end{matrix}$$

By obtaining the base spectrum data based on the calculation as described above, the frequency component included in the base spectrum data is an average intensity of the N-divided analysis results regardless of the synchronization with the analysis period signal in the frequency component included in the analysis result.

Further, in step S156, the synchronization with the analysis period signal can be determined by comparing the intensity of each frequency component of the enhancement spectrum data SS and the base spectrum data BS. At this time, a value obtained by multiplying the intensity of each frequency component of the enhancement spectrum data SS by √N is compared with the intensity of each frequency component of the base spectrum data BS. That is, a frequency component in which a value obtained by multiplying the intensity of the enhancement spectrum data SS by √N is larger than the intensity of the base spectrum data BS can be determined as a frequency component synchronized with the analysis period signal, and a frequency component in which a value obtained by multiplying the intensity of the enhancement spectrum data SS by √N is equal to or smaller than the intensity of the base spectrum data BS can be determined as a frequency component not synchronized with the analysis period signal.

The frequency component of the analysis result synchronized with the analysis period signal can be estimated as a noise frequency component derived from the enable interval selected by the control PC. The frequency component of the analysis result that is not synchronized with the analysis period signal can be estimated not to be the noise frequency component derived from the enable interval selected by the control PC.

In step S157, it is determined whether the processing is completed at all frequencies, and if not completed, the processing of step S156 is repeated until the processing is completed.

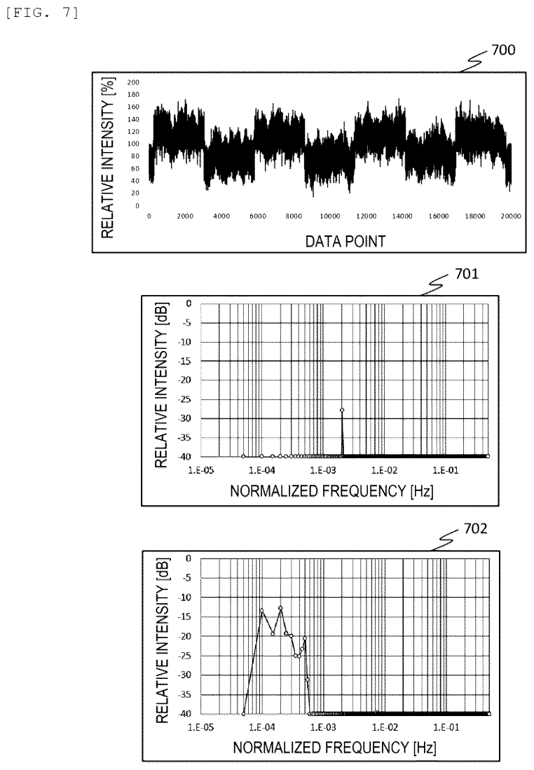

FIG. 6 is a diagram showing an operation principle of the noise matcher 123 in the abnormality detection module 120 according to the present embodiment. In FIG. 6, the noise matcher 123 matches noise data stored in a memory resource 602 using a noise matching controller 601 based on the frequency component determined to be synchronized with the analysis period signal and the selection signal input from the control PC 116, and outputs corresponding noise information as a matching result.

As shown in FIG. 6, in the noise data stored in the memory resource 602, for example, noise frequency components are listed for each enable interval stored in the memory resource 401 of the sync selector 121. The noise information is stored for each noise frequency component of each enable interval. The noise information may include radio frequency band information and modulation information.

The noise information includes, for example, a module name of a noise source, an identification number of a cable or a connector, and a process number of a maintenance manual in which a work process when a noise countermeasure is performed is described. In addition, a work method for taking measures against noise may be displayed.

The matching result display 124 in the abnormality detection module 120 displays the matching results input from the noise matcher 123 to an operator. At the time of display, an alert may be issued by a buzzer or a lamp from the measurement device. A timing of displaying the matching results and a timing of issuing the alert may be immediately after the matching results are input or may be set by the operator. In addition, the operator may set a type of the matching result to be displayed in advance, and only the matching result to be displayed may be displayed. A memory resource may be provided, and the matching result may be stored as log information in the memory resource at the time of display.

By performing the noise matcher 123 for all the enable intervals stored in the memory resource 401, it is possible to determine the synchronization of the noise superimposed on the analysis result in all the modules stored in the memory resource 401.

As described above, according to the present embodiment, it is possible to estimate the noise source to be superimposed on the analysis result in all the components which are the units and the modules provided in the measurement device assumed to be the noise source. Accordingly, it is possible to provide a measurement device capable of reducing a work time for identifying the noise source and reducing a maintenance time.

### Embodiment 2

In Embodiment 1, a method for estimating the noise source by storing the enable intervals of the assumed components which are all of the units and modules in the memory resource of the sync selector and determining the synchronization with the internal noise superimposed on the analysis result is described. In the present embodiment, a noise determination method for noise flowing from the outside of the measurement device will be described.

An abnormality detection module as a noise determination unit in the present embodiment has a structure same as that of the abnormality detection module in Embodiment 1. However, the information of the enable interval stored in the memory resource 401 of the sync selector 121 stores all assumed noise sources in the measurement device. In addition, the memory resource 602 of the noise matcher 123 stores noise information of assumed external noise, and the noise matching controller 601 includes a unit for storing the type of the selection signal subjected to the noise determination and the syn determination result.

In the method for determining the noise flowing from the outside of the measurement device, first, the processing in the syn determination unit 122 in Embodiment 1 is executed for all enable intervals stored in the memory resource 401 to determine the synchronization of the noise superimposed on the analysis result in all the units and modules stored in the memory resource 401. Next, the noise matching controller 601 of the noise matcher 123 refers to the stored syn determination result for each selection signal, and when there is a frequency component that is asynchronous with all enable intervals in the frequency components of the noise superimposed on the analysis result, the frequency component is determined to be the external noise, and the noise information of the external noise stored in the memory resource 602 is output as the matching result. In addition, in the frequency component of the noise superimposed on the analysis result, the frequency component determined to be synchronized with one or more enable intervals is set as the internal noise, and the noise information is output as the matching result.

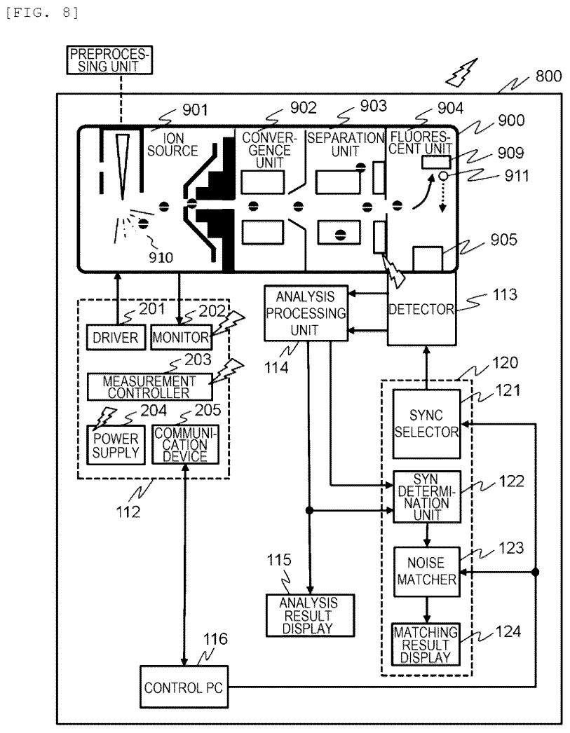

FIG. 7 shows an example of a result of determination obtained by the noise determination method according to the present embodiment. In FIG. 7, an upper analysis result 700 is an example in which a relative intensity is a constant value of 100% in a normal analysis result, and the external noise is superimposed on the internal noise to indicate a rectangular wave shape. Examples of results obtained by obtaining the frequency components of the internal noise and the external noise by the noise determination method according to the present embodiment are shown in the middle and bottom parts of FIG. 7. Reference numeral 701 in the middle part denotes the internal noise, and reference numeral 702 in the lower part denotes the external noise. Here, the relative intensity [dB] is based on the intensity of a normal analysis result (0 dB), and indicates a frequency intensity of the base spectrum data BS. The frequency component displayed by the internal noise 701 is noise due to the communication signal between the control PC 116 and the communication device in the device control module 112, and the frequency component displayed by the external noise 702 is noise entering from the outside of the measurement device using an antenna which is a test facility of EMC. From this, it can be confirmed that the internal noise and the external noise can be determined.

As described above, according to the present embodiment, it is possible to determine the noise source of the noise flowing from the outside of the assumption device and superimposed on the analysis result, and it is possible to shorten a work time for identifying the noise source.

### Embodiment 3

In Embodiments 1 and 2, the method for estimating the noise source of the noise superimposed on the analysis result in the measurement device is described. In the present embodiment, a method for estimating the noise source of noise superimposed on the analysis result in a mass spectrometer will be described as a specific example of a measurement device.

FIG. 8 is a configuration block diagram of a mass spectrometer 800 according to the present embodiment. In FIG. 8, the components same as those in FIG. 1 are denoted by the same reference numerals, and description thereof is omitted. FIG. 8 is different from FIG. 1 in that the measurement unit 111 is replaced with a mass spectrometry unit 900.

In FIG. 8, the mass spectrometry unit 900 includes an ion source 901 that ionizes a sample to be analyzed sent from a preprocessing unit, a convergence unit 902 that converges an ionized sample 910, a separation unit 903 that passes only an ionized sample to be detected by filtering the converged ionized sample according to a mass-to-charge ratio, and a fluorescent unit 904 that causes the ionized sample passing through the separation unit to collide with a conversion die node 909, convert the ionized sample into an electron 911 according to an amount of the ionized sample, and output a photon according to an amount of the electron by causing the electron 911 to enter a scintillator 905. The detector 113 outputs an electrical signal corresponding to the photon output from the fluorescent unit 904.

The abnormality detection module 120 stores, in the memory resource 401 of the sync selector 121, all the enable intervals that can be the noise sources of the components that are the units and the modules mounted in the mass spectrometer 800, and thus, as described in Embodiments 1 and 2, the synchronization of the noise superimposed on the analysis result can be determined and the noise source can be estimated.

When the frequency component of the noise superimposed on the analysis result includes the frequency component not synchronized with all the enable intervals, the frequency component can be determined to be the external noise.

As described above, according to the present embodiment, it is possible to provide a mass spectrometer capable of estimating a noise source to be superimposed on an analysis result in all of components which are units or modules provided in the mass spectrometer assumed to be a noise source, reducing a work time for identifying the noise source, and reducing a maintenance time.

Embodiments of the invention are described, and according to the invention, a work time for identifying a noise source can be shortened, thereby making it possible to reduce a maintenance time, and an effect of improving productivity and reducing personnel cost is achieved. Therefore, the invention contributes to achieving high levels of economic productivity through technological improvement and innovation in order to achieve the Sustainable Development Goals (SDGs), particularly in goal 8, “Decent work and economic growth”.

The invention is not limited to the embodiments described above, and includes various modifications. For example, the above-described embodiments have been described in detail to facilitate understanding of the invention, and the invention is not necessarily limited to those including all the configurations described above. A part of a configuration of a certain embodiment can be replaced with a configuration of another embodiment, and the configuration of another embodiment can be added to the configuration of a certain embodiment. A part of a configuration in each embodiment may also be added to, deleted from, or replaced with another configuration.

### REFERENCE SIGNS LIST

100: measurement device
110: device module
111: measurement unit
112: device control module
113: detector
114: analysis processing unit
115: analysis result display
116: control PC
120: abnormality detection module
121: sync selector
122: syn determination unit
123: noise matcher
124: matching result display
201: driver
202: monitor
203: measurement controller
204: power supply
205: communication device
301, 302, 700: analysis result
303: noise
401, 602: memory resource
402: detection control signal generator
601: noise matching controller
701: internal noise
702: external noise
800: mass spectrometer
900: mass spectrometry unit

1. A measurement device comprising:
a measurement unit configured to measure a measurement target and output a measurement signal;
a detector configured to detect the measurement signal and output a detection signal;
an analysis processing unit configured to calculate and output an analysis result from the detection signal;
an analysis result display configured to display the analysis result;
a device control module configured to control the measurement unit and output a control signal; and
an abnormality detection module configured to detect noise in the measurement device, wherein
the abnormality detection module stores an enable interval of each of the components of the measurement device into a memory resource, and determines, for each of the components of the measurement device, whether the noise is mixed in based on the corresponding enable interval stored in the memory resource and the analysis result from the analysis processing unit.

2. The measurement device according to claim 1, wherein
the abnormality detection module
determines, for each of the components of the measurement device, synchronization between the corresponding enable interval stored in the memory resource and a frequency component of the analysis result,
determines, when there is a frequency component among frequency components of the noise superimposed on the analysis result which is asynchronous with all of the enable intervals stored in the memory resource, the frequency component to be external noise, and determines a frequency component that is synchronous with one or more of the enable intervals stored in the memory resource to be internal noise, and
outputs noise information of the determined external noise or internal noise as a matching result from a second memory resource in which noise information of assumed external noise and internal noise is stored.

3. The measurement device according to claim 2, wherein
the determination of the synchronization is performed by comparing baseline spectrum data with enhancement spectrum data obtained by statistical calculation that enhances components of the enable intervals,
the baseline spectrum data is spectrum data generated by performing frequency analysis on the analysis result and then performing ensemble average calculation, and
the enhancement spectrum data is spectrum data generated by dividing the analysis result into a plurality of sections at the enable intervals, then performing the ensemble average calculation, and then performing the frequency analysis.

4. The measurement device according to claim 2, wherein
the abnormality detection module is allowed to select a timing of outputting the noise information as the matching result and a type of the output, and to issue an alert using a buzzer or a lamp.

5. The measurement device according to claim 2, wherein
the noise information includes frequency information and modulation information.

6. A mass spectrometer comprising:
a measurement unit configured to measure a measurement target and output a measurement signal;
a detector configured to detect the measurement signal and output a detection signal;
an analysis processing unit configured to calculate and output an analysis result from the detection signal;
an analysis result display configured to display the analysis result;
a device control module configured to control the measurement unit and output a control signal, the measurement unit includes an ion source, a convergence unit, a separation unit, and a fluorescent unit; and
an abnormality detection module configured to detect noise in the mass spectrometer, wherein
the abnormality detection module
determines, for each of the components of the mass spectrometer, synchronization between an enable interval of the corresponding component of the mass spectrometer stored in a memory resource and a frequency component of the analysis result,
determines, when there is a frequency component among frequency components of the noise superimposed on the analysis result which is asynchronous with all of the enable intervals stored in the memory resource, the frequency component to be external noise, and determines a frequency component that is synchronous with one or more of the enable intervals stored in the memory resource to be internal noise, and
outputs noise information of the determined external noise or internal noise as a matching result from a second memory resource in which noise information of assumed external noise and internal noise is stored.
